(19) United States
(12) Patent Application Publication
(10) Pub. No.: US 2017/0353604 A1
(43) Pub. Date: Dec. 7, 2017

(54) METHOD OF FILTERING MESSAGES TO PROVIDE A "DO NOT DISTURB" FUNCTION

(71) Applicant: Orange, Paris (FR)

(72) Inventors: Robin Martine, Paris (FR); Richard Tucker, Billericay (GB)

(21) Appl. No.: 15/521,089

(22) PCT Filed: Oct. 16, 2015
(86) PCT No.: PCT/FR2015/052789

§ 371 Date: Apr. 21, 2017

(30) Foreign Application Priority Data
Oct. 23, 2014 (FR) 1460201

(51) Int. Cl. H04M 3/436; H04W 4/12; H04W 4/16

(52) U.S. Cl. CPC H04M 3/4365; H04W 4/16; H04W 4/12; H04M 2203/2005

(57) ABSTRACT

A method is described of filtering messages sent by a first terminal to a second terminal, the first terminal being associated with a first identifier, the terminals being connected via at least one communication network, the communication network including a server connected to a database, and the database including at least a first predefined set of identifiers. The server receives a message sent by the first terminal to the second terminal, records the message in the database, and sends a second message to the first terminal. The second message includes a sender field including a second or third identifier depending on whether or not the first identifier belongs to the first list.

### TECHNICAL FIELD TO WHICH THE INVENTION RELATES

The present invention relates generally to the field of communication systems, and more specifically the provision of a “Do Not Disturb” service.

### TECHNOLOGICAL BACKGROUND

The significant expansion of mobile terminals such as mobile phones, “smartphones”, tablets, pagers is accompanied by an intensification of their uses. Today these terminals offer a quasi-permanent connectivity to their users who may be reached at any time. Telephone calls, messages or various notifications may then become very frequent and some users may be bothered by this, describing the use of these terminals as invasive.

A simple solution is obviously to switch off these terminals, but this is not always desirable since it then totally excludes any possibility of being reached, even for a possible emergency. Likewise, when placed in “airplane” mode (i.e., disconnected from the communication network), or in “silence” mode, these terminals will not retain the possibility of being reached in case of emergency, the user no longer being notified of calls received. These methods are effective for not being disturbed, but they have the drawback of not offering any adaptability to being reached in case of a possible emergency.

Methods or services have therefore been developed to limit the intrusion of these terminals, without, however, entirely excluding the possibility of being reached in case of need. This involves a “Do Not Disturb” service.

A service of this type is described in French patent FR9714784. This document describes a system allowing a telephone operator to offer its users activation of a “Do Not Disturb” service at their request. If a user activates the service, then future calls to this user are intercepted—or filtered—by the operator, who informs the caller via a voice message that the user does not wish to be disturbed. Callers, however, retain the possibility of overriding the filtering—via a sequence to be typed on the keys of their telephone—and nevertheless have their call transmitted to the user. The system is therefore based solely on the decision of the caller, who remains the sole judge of the urgency or the appropriateness of disturbing the user.

American patent U.S. Pat. No. 5,467,388 describes a system for offering a selective blocking of calls, which can be used to offer a “Do Not Disturb” service. The service offers a user the possibility of configuring a list of privileged contacts (“white list”). When the user activates the “Do Not Disturb” service, the calls from contacts belonging to the white list are transmitted. Conversely, other calls are blocked. The user may also specify access codes. A caller must then provide a correct access code to be placed in contact with the user. The user therefore gains some control over who can disturb them through setting up the white list or the possibility of providing access codes to certain people.

The international patent application WO0161978 describes another system for offering a “Do Not Disturb” service. In this system, the user may also configure an access code, a code which will be required from any caller when the “Do Not Disturb” service is active. If the caller supplies the correct code, their call will be directed to the user. Otherwise, the call will be redirected to a voicemail.

The preceding solutions, based on white lists or access codes have the drawback of not being able to manage the case of an urgent call from an unknown caller (which therefore cannot have been previously included in a white list, or to which an access code cannot have been previously provided). Unpredictable cases are therefore all filtered by default even though they may sometimes be of an emergency nature.

The solutions for providing a “Do Not Disturb” service previously described are in addition intended for voice call communications and are not suited to Short Message Service (SMS) or Multimedia Messaging Service (MMS) messages, for example.

Today, therefore, there is a need for a solution for offering a “Do Not Disturb” service, a solution capable of managing the case of unpredictable messages.

### SUBJECT MATTER OF THE INVENTION

The invention proposes remedying the drawbacks previously discussed by providing a method of filtering messages sent by a first terminal, identified by a first identifier, to a second terminal, the terminals being connected via at least one communication network, the communication network including a server connected to a database, the database including at least one first predefined list of identifiers, the server executing the following steps: receiving a first message sent by the first terminal to the second terminal, recording the first message in the database, determining whether the first identifier belongs to the first list and, if so, sending a second message to the first terminal, the second message including a sender field matching a second identifier, or, if not, sending a second message to the first terminal, the second message including a sender field matching a third identifier.

Advantageously, it is therefore possible to intercept and record a first message to the second terminal. The user of the second terminal will therefore not be disturbed by receiving the first message on the second terminal, the first message not being received by the second terminal but intercepted and recorded by the server. Indeed, receiving a message on a terminal is often accompanied by a ringtone, vibration and/or visual effect on the screen of the terminal that may be regarded as disturbing at certain times by the user of a terminal. The second message is used to warn the first terminal of the interception of the first message, and therefore its non-delivery to the second terminal. According to whether or not the first identifier—typically a telephone number—belongs to the first list, the identifier of the sender of the second message will be different. It will correspond to a second identifier if the first identifier belongs to the first list or else to a third identifier. This allows a differentiated service to be offered to the user of the first terminal according to whether or not their terminal is identified as belonging to the first list. Indeed, in response to the second message, if the user of the first terminal chooses to respond to this second message, they will therefore respond by sending a message to an identifier that will differ according to the circumstances. The user of the second terminal may therefore, by using the first list of identifiers—e.g. a first list of telephone numbers in a GSM/UMTS context—choose a differentiated response for different users. These users are identified by their telephone numbers, e.g. by putting the numbers corresponding to the terminals of known or priority users into the first list. These users will therefore receive a second message with the second identifier as the sender identifier.

According to a complementary embodiment of the present invention, the method includes the following subsequent steps of receiving a third message sent by the second terminal requesting the deactivation of the filtering service provided by the present method and of sending to the second terminal the messages recorded in the database which are intended for it.

Advantageously, the user of the second terminal may therefore deactivate the message filtering service according to the present request by sending a third message. Messages sent to the second terminal will then be processed normally, i.e. without interception or recording, once the service is deactivated. All the messages that might be received by the server intended for the second terminal and recorded in the database are then sent to the second terminal. This can therefore be used to delay message reception during the activity period of the filtering service, the recorded messages only being delivered when the user of the second terminal deactivates the service, thus terminating the “Do Not Disturb” period. They then receive any message which they would have been sent during the “Do Not Disturb” period and which would have been intercepted and recorded by the server.

According to another complementary embodiment, the method includes the following subsequent steps of receiving a fourth message sent by the first terminal, the recipient field of the fourth message including a fourth identifier, and, if the fourth identifier matches the second identifier or if the fourth identifier matches the third identifier, then a recorded message is retrieved in the database and is sent to the second terminal, or, if not, the fourth message is ignored.

The user of the first terminal, after having received a second message in response to their first message, may unblock the sending of their first message by sending a fourth message, a fourth message that has as a destination identifier the identifier corresponding to the sender field of the second message that they have received in return for the first to message sent. The first message is thus unblocked, i.e. it is retrieved in the database and sent to its recipient, i.e. the second terminal. This method may advantageously be used to provide a “Do Not Disturb” service to the second terminal while preserving the possibility of an unpredictable case. Indeed, any user of the first terminal who sends a first message to the second terminal receives in return a second message, whether or not it is previously known, or in other words, whether or not it is previously identified in a first list. This user of the first terminal therefore keeps the possibility of responding to the second message—with full knowledge of the facts—to unblock the delivery of a first recorded message. The user of the first terminal is therefore warned of the “Do Not Disturb” status of the second terminal by the second message, and, if nevertheless it is in their judgment appropriate to disturb the second user, may unblock the delivery of the first message. The delivery of the first recorded message will take place via a fifth message intended for the second terminal. The possibility therefore remains open of reaching a second terminal despite the “Do Not Disturb” status.

According to a complementary embodiment, the retrieved message is the last of the recorded messages, sent by the first terminal and intended for the second terminal, the method including a subsequent step of deleting this retrieved message from the database after it has been sent to the second terminal.

Advantageously, the server sends the last first message sent by the first terminal to have been recorded in response to a fourth message received from this same terminal, on a principle comparable to a “first in, first out” operation.

According to another alternative embodiment, the second message includes a first reference for identifying the first message recorded in the database, the fourth message includes a second reference corresponding to the first reference and the message sent to the second terminal is retrieved in the database thanks to the second reference.

Advantageously, this allows a first user who has sent multiple first messages to select the first message to be unblocked—i.e. to be retrieved then sent to the second terminal. The selection is made by indicating a reference in the fourth message, this reference having been provided in the second message. The first recorded messages are therefore not unblocked according to a “first in, first out” mode but according to a selection by the first user, the selection made thanks to the first reference provided in the second message.

According to a complementary embodiment, the database includes a second predefined list of identifiers, the method further including the following steps after the to reception of the first message: determining whether the first identifier belongs to the second list and, if so, transmitting the first message to the second terminal without sending the second message.

Advantageously, the first messages received from a terminal the identifier of which belongs to the second list are directly transmitted to the second terminal, even though the “Do Not Disturb” service is active for this second terminal. This is particularly advantageous if the identifiers of the second list are particular identifiers such as identifiers corresponding to the emergency services (fire department, hospitals, civil security, etc.) or to certain identifiers previously identified by the user of the second terminal, the messages from these identifiers not having to be filtered.

According to a complementary embodiment, the database includes a third predefined list of identifiers, the method further including the following steps after the reception of the first message: determining whether the first identifier belongs to the third predefined list and, if so, recording the first message in the database without sending the second message.

In contrast to the preceding embodiment, but in a complementary way, this embodiment can be used to directly record—without sending a second message in return—a first message received from a terminal the identifier of which belongs to a third predefined list. The possibility of unblocking by sending a fourth message is therefore not offered to the first terminal. This is particularly advantageous with regard to identifiers corresponding to “robot” terminals or “automatic message sending servers”. Indeed, these robots are unable to process a second message, and it is therefore pointless to clutter up the communications networks with second messages that would be intended for them. In addition, these robots often respond to messages that are sent to them with an automatic message specifying their robot status and reporting that the message will not be read or processed since it is sent to a robot. A situation could then occur where the robot and the server enter a perpetual loop of sending reciprocal messages. A situation could also occur where since the automatic response of a robot to a second message corresponds to a fourth message, any first message sent by a robot would therefore be automatically—without a validation step by a first user capable of assessing the urgency or appropriateness of disturbing the second user—unblocked to the second terminal. In other words, any robot would short-circuit the “Do Not Disturb” service automatically. The fact of placing the identifiers corresponding to robots in the third list can be used to overcome this. The messages sent by these robots will not therefore be automatically delivered when the second user deactivates the “Do Not Disturb” service. It should be noted that identifiers to corresponding to robots may also be placed in the second list, e.g. a robot corresponding to an emergency service.

According to a complementary embodiment, at least one of the second and third identifiers corresponds to a value-added service number.

Advantageously the second identifier, the third identifier, or both identifiers, correspond to value-added service numbers, otherwise known as “premium rate numbers”. This creates a deterrent effect since there is then a real cost to disturbing the second user, a cost which takes the form of sending the fourth message to a value-added service number. In choosing a lower cost value-added service number for the second identifier than for the third identifier, or even one of zero cost, the user of the second terminal can encourage users whose identifiers are included in the first predefined list. In contrast, the users of terminals whose identifiers are not included in the first predefined list may have a strongly deterrent cost applied for unblocking their first messages by setting a significant cost for the value-added service number corresponding to the third identifier.

According to a complementary embodiment, the messages are of the short message type.

According to another complementary embodiment, a message includes at least one short message.

Advantageously, the method applies to the exchange of SMS (Short Message Service) short messages or MMS (Multimedia Messaging Service) messages between different terminals. The same SMS message may in fact include multiple SMSs because of the technical limit of 160 characters (according to the coding) for a single SMS.

The invention also provides a server implementing the method of filtering messages according to the various embodiments previously described. This server may be partly the second terminal. In other words, the method may be directly executed partly and locally by the second terminal. The interception of a message may then be included through its non-presentation to the user by the second terminal, or a more discreet presentation. For example, for a second terminal including a “normal” mode of presentation of the messages and another “discreet” mode, the first messages will be presented according to the “discreet” mode (respectively not presented) when the fifth messages, corresponding to first unblocked messages, will be presented according to the “normal” mode (respectively to in “discreet” mode).

The method for filtering messages sent by a first terminal to a second terminal according to the invention may be implemented in the form of a computer program, this program being executed, for example, by one or more processors of a server connected to a database and to at least one communication network. Consequently, according to one last aspect, the subject matter of the present invention is a computer program comprising program instructions for implementing all or part of the steps of the method for filtering messages sent by a first terminal to a second terminal, when this program is executed by a processor.

Moreover, a computer program according to the invention may use any programming language, and be in the form of source code, object code, or intermediate code between source code and object code, such as in a partially compiled form, or in any other desirable form.

Consequently, the invention is also aimed at a medium for recording information readable by a computer, and comprising computer program instructions according to the invention. Such a recording medium may consist of any entity or device capable of storing such a program. For example, the medium may comprise a storage means, such as a ROM (Read Only Memory), e.g. a CD-ROM or a microelectronic circuit ROM, or a removable recording means, such as a USB stick or a magnetic recording means, such as a hard disk. On the other hand, a software program or module according to the invention may in particular be downloaded from an Internet type network. The advantages provided by a computer program, as briefly defined above, are identical or contribute to those mentioned above in relation to the method for filtering a message sent by a first terminal to a second terminal, and will therefore not be recalled here.

### DESCRIPTION OF THE FIGURES

FIG. 1A represents a server for implementing the method in accordance with an embodiment of the invention,

FIG. 1B is a schematic representation of a system complying with an embodiment of the invention,

FIG. 2 is a flow chart illustrating the implementation of the invention according to an embodiment of the invention.

### DETAILED DESCRIPTION

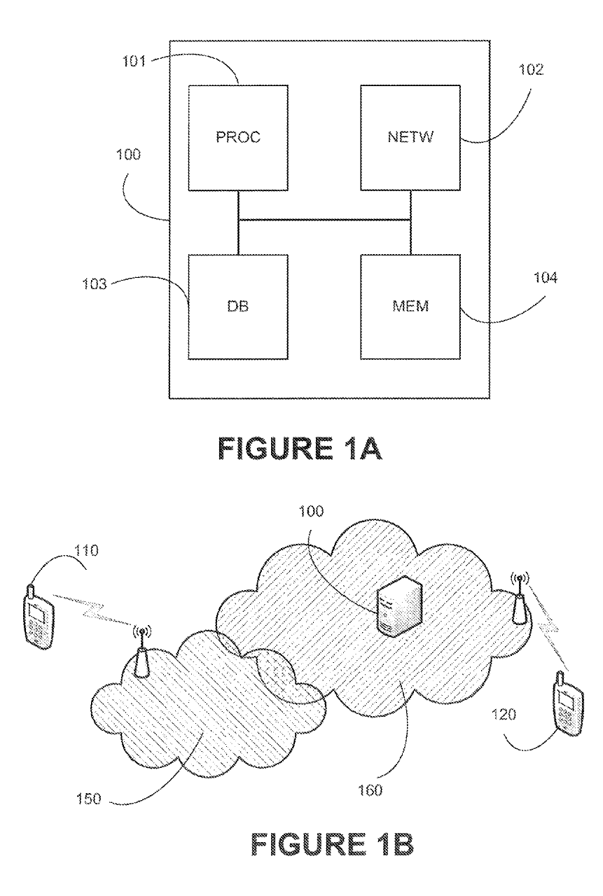

FIG. 1A represents a server for implementing the method in accordance with an embodiment of the invention.

The server 100 may include a processor 101, a network module 102, a data storage space 103 and RAM (Random Access Memory) memory 104. The server 100 corresponds in this example to physical equipment, i.e. a computer hardware device. The processor 101 may comprise one or more cores, or may correspond to multiple processors. The network module 102 provides the connection means to at least one communication network. Since the server 100 is intended to be integrated into a communication network, the technology used by the network module 102 may vary according to the technology used in the communication network. The network module may, for example, comprise an “Ethernet” socket and offer IP (Internet Protocol) connectivity to the server 100. The network module 102 therefore allows the server 100 to receive and send (or transmit) messages via the communication network. The data storage space 103 may correspond to physical or virtual hard disks, accessible locally or via the network module 102. The storage space 103 allows the server 100 to create, modify, manage databases, and therefore record data, e.g. messages, in a database. These databases may be shared with other servers, i.e. being created, managed, or accessible from other servers.

In order to simplify the description of the present invention, the reference 103 will be used hereafter as designating a database connected to the server 100. This database 103 may therefore be local, i.e. included in the storage space of the server 100, or remote, i.e. included in another server or plurality of servers. The server 100 may therefore record in the database 103 messages received via the network module 102. The server 100 may also retrieve recorded messages in the database 103 and send these messages via the network module 102. The server 100 may also record or retrieve lists of identifiers in the database 103. The server 100, via the processor 101 may thus determine whether an identifier of a message received via the network module 102 belongs to an identifier list.

According to the implementations, the server 100 may alternatively be implemented as a virtual machine of a virtualization server, or have its functions integrated into another server providing other applications or functions.

FIG. 1B is a schematic representation of a system complying with an embodiment of the invention. This figure represents a first terminal 110 connected to a communication network 150 and a second terminal 120 connected to a communication network 160. The communication network 160 is possibly the same as the communication network 150. The server 100 is represented here as included in the communication network 160. The server 100 may also be a physical device independent of the communication network 160 and connected to it. The server 100 may also have its functions and capabilities integrated into another server already providing other services for the communication network 160.

These communication networks 150 and 160 are typically GSM/UMTS networks, the terminals 110 and 120 being mobile phones, tablets, smartphones, etc.

In this context of GSM/UMTS communication networks 150 and 160, the identifiers associated with the terminals 110 and 120 are also termed phone numbers (or “numbers”).

The terminals 110 and 120 are therefore capable of establishing any type of communication as is known for GSM/UMTS communication networks. For example, the terminals 110 and 120 are capable of exchanging short message messages, also known as SMS (Short Message Service). Since a single SMS has a size limited to 160 characters (according to the coding), a message comprising a text with a length exceeding this limit may therefore be composed of multiple concatenated SMSs.

In the implementation of the present invention illustrated in FIG. 1B, the server 100 is included in the communication network 160. In an alternative embodiment, the server 100 may be included in the communication network 150 or in another communication network not represented in this FIG. 1B. This will be particularly the case if the terminal 120 is in a “roaming” situation, i.e. it is not connected to its usual communication network. In an alternative embodiment, all the functions—or only certain functions—of the server 100 are integrated into a server providing other services. In particular, in one embodiment, the functions of the server 100—or only certain functions—are performed by the terminal 120.

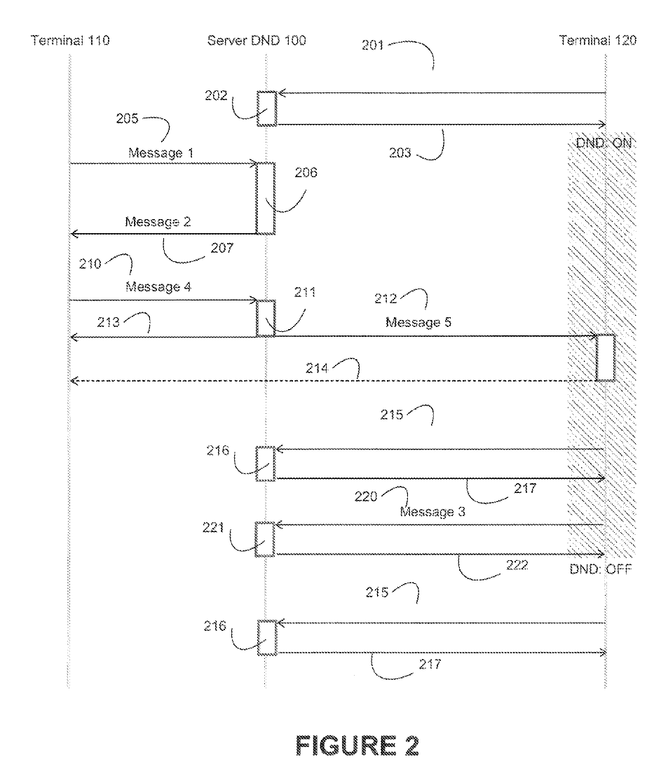

FIG. 2 is a flow chart illustrating the implementation of the invention according to one embodiment. This figure describes various message exchanges according to an implementation of the method provided for filtering messages sent by the terminal 110 to the terminal 120. This method of filtering can be used to provide the user of the terminal 120 with a “Do Not Disturb” or DND service. According to the embodiment illustrated in FIG. 2, the server 100 is compliant with the previously described server 100. For the sake of simplicity in the description of FIG. 2, the terminals 110 and 120 and the server 100 will be considered as included in the same communication network, e.g. of the GSM/UMTS type, without this being in any way limiting. In an initial state, the operation of the terminals 110 and 120 is compliant with the conventional operation of GSM terminals. In particular, these terminals can exchange SMS short messages. A message sent by the terminal 110 will therefore be transmitted by the communication network and received by the terminal 120, which will indicate the reception of this message by vibrating, ringing or displaying a notification, potentially bothering the user of the terminal 120. The user of the terminal 120 who wishes to limit these disturbances may therefore activate a “Do Not Disturb” service, which will be provided by setting up the method of filtering described in this document.

According to one embodiment, the user of the terminal 120 wishing to use the “Do Not Disturb” service may have to install an application on their terminal 120 to use the service. The application will be installed according to the usual known process, e.g. by going to retrieve this application from an application store such as Google Play, the Apple App Store or the Windows Phone Store, to name just the main stores used today. Alternatively, the application will be pre-installed on the terminal 120 by the operator of the communication network or the manufacturer of the terminal 120, or even incorporated directly into the OS (Operating System) of the terminal. The user of the terminal 120 may also go to retrieve the application on a site of a communication network operator. As will be described in detail farther on, one function of the application is in particular to activate or deactivate the “Do Not Disturb” service, said activation or deactivation being done by sending a message to the server 100. This message may be of any type, in particular SMS or USSD (Unstructured Supplementary Service Data). More generally, the messages exchanged between the second terminal 120 and the server 100 may be of any type, e.g. USSD or data messages transmitted by an IP (Internet Protocol) technology.

According to a complementary embodiment, the user of the terminal 120 does not need to install or use any particular application and may activate the service by communicating with the server 100 by any method. The user may indeed send SMS or USSD messages directly without having to go through a particular application. The user may also access the service, i.e. activate it, deactivate it or configure it via a web interface. The server 100 may or may not host the web server allowing the configuration of the service. According to a particular embodiment, the installation of an application will be mandatory on the terminal 120, the application being able to comprise authentication mechanisms for communicating securely with the server 100 providing the message filtering service.

Thus, in a first step 202, the service for filtering messages to the terminal 120 is activated. In one embodiment, the activation of the service is triggered by the reception of a message 201 sent by the terminal 120. The server 100 thus receives a message 201 sent by the second service activation terminal. According to an alternative embodiment, the message 201 may be sent by other equipment and comprises an identifier of the terminal 120. The message 201 may comprise one or more instructions for requesting the activation of the filtering service. When activating the service for the terminal 120, the server 100 retrieves in the database 103 one or more predetermined lists associated with the terminal 120. These lists include identifiers and therefore can be used to customize the filtering of messages sent to the terminal 120 according to the identifier of the sender of the messages. Alternatively, lists may be included in the activation message received. Lists may also be retrieved on another remote server, e.g. a server operated by the provider of the “Do Not Disturb” service.

A first identifier list, a “green list” may thus be set up. This green list may be set up by the user of the terminal 120 or by the operator of the “Do Not Disturb” service. The point of this list is to define identifiers for which the delivery of the messages to the terminal 120 will be immediate. Indeed, if the server 100 determines that an identifier of the sender of a message to the terminal 120 belongs to the green list, then this message will be transmitted directly to the terminal 120 without executing the subsequent steps of the method of filtering. In other words, these messages from identifiers in the green list are not filtered. This green list therefore corresponds to emergency service identifiers (fire department, etc.) or identifiers added by the user of the terminal 120 according to their needs. The user of the terminal 120 thus keeps the possibility of adding identifiers for which filtering will not be performed even when the “Do Not Disturb” service is active. The part of the list corresponding to emergency service identifiers may be common to all the users of the “Do Not Disturb” service.

Another identifier list, a “gray list” may also be set up. This gray list may include “short number” or “premium rate” identifiers or more generally identifiers corresponding to services. This first identifier source for the gray list may be set up by the operator of the “Do Not Disturb” service by the user of the terminal 120, or by the service operator and the user of the terminal 120. A second identifier source for this list is the user of the terminal 120 who may add identifiers at their convenience. This list is intended to determine identifiers for which the method of filtering will be partially performed. As will be seen farther on in this description, the messages from these identifiers will be recorded by the server 100 in the database 103 without a message 207 being sent in return. These messages will only be delivered when the user of the terminal 120 deactivates the “Do Not Disturb” service.

The part of the gray list corresponding to “short number” or “premium rate” service identifiers may be common to all the users of the “Do Not Disturb” service.

One or more other identifier lists, “white lists”, may be defined. These white lists are a priori set up by the user of the terminal 120 and correspond to identifiers that the user of the terminal 120 wishes to prioritize. A different identifier NUM i may be associated with each white list i.

All these lists are recorded in the database 103 in association with the identifier NUM 120 of the terminal 120. Possibly, all or part of these lists are common to one or more users of the “Do Not Disturb” service.

Thus, on reception of the message 201 activating the “Do Not Disturb” service by the server 100, one or more predetermined lists, e.g. of the green, gray or white type, associated with the terminal 120 are obtained from the database 103. The method of filtering allowing the provision of a “Do Not Disturb” service is then started and will apply to the messages subsequently sent to the terminal 120.

This phase of activating the service may include a phase of modifying the routing of the messages to the terminal 120 within the communication network 160 so that following the activation of the service all the messages to this terminal 120 pass through the server 100. Alternatively, as described hereafter, the step of determining whether the identifier of the sender field (hereafter, the sender identifier) of a message to the terminal 120 belongs to one of the predefined lists may be performed by other equipment of the communication network 160, only the messages requesting particular processing (recording, for example) then passing through the server 100. In other words, determining whether the sender identifier of a message belongs to the green list may be performed on a server other than the server 100.

Following step 202, the “Do Not Disturb” service is therefore active for the terminal 120. According to one embodiment, a message 203 confirming the successful activation of the service is sent to the terminal 120.

Step 206 corresponds to the reception by the server 100 of a message 205 sent by a terminal 110 to the terminal 120, the identifier associated with the terminal 110 being NUM 110.

Assuming that the verification of whether NUM 110 belongs to the green list associated with the terminal 120 has not been previously performed by another server, it will then be determined whether NUM 110 belongs to the green list. If this is the case, then, as seen previously, the message 205 will be transmitted directly to the terminal 120 without sending the second message 207.

Likewise, if it is determined that NUM 110 belongs to the gray list associated with the terminal 120, then, as seen previously, the message 205 will be recorded in the database 103 without sending the second message 207. These messages sent by a terminal 110 the identifier of which belongs to a gray list and recorded in the database 103 will be sent to the terminal 120 on the deactivation of the service.

In other cases, the message 205 is recorded in the database 103. The server 100 then determines whether NUM 110 belongs to a pre-defined list associated with the terminal 120. If NUM 110 belongs to a list, e.g. a white list i, then the server sends a message 207 to the terminal 100, the message 207 having as the sender identifier the NUM i associated with the white list. In other words, the message 207 includes a sender field that matches the identifier NUM i.

If NUM 110 does not belong to a predefined list of identifiers, then the server 100 sends a message 207 to the terminal 100, the message 207 having as the sender identifier an identifier NUM d. In other words, the message 207 includes a sender field that matches the identifier NUM d.

The message 207 includes a text informing the user of the terminal 110 that their message 205 was not delivered to their correspondent since the latter has activated the “Do Not Disturb” service. The user of the terminal 110 is therefore informed that the user of the terminal 120 does not wish to be disturbed. However, if the user of the terminal 110 nevertheless wishes to disturb the user of the terminal 120 and force sending their message 205 to the terminal 120, the method of the present invention allows this as described in detail below. The assessment of the urgency of the situation therefore rests both with the user of the terminal 120 via the definition of predefined lists, and with the user of the terminal 110 who will alone decide whether it is appropriate to disturb the user of the terminal 120 after receiving a message 207.

If the user of the terminal 110 judges that their message 205 is not urgent and that they therefore do not wish to disturb the user of the terminal 120, the user of the terminal 110 need perform no further action. Their message 205 is recorded in the database 103 and will be sent automatically by the server 100 to the terminal 120 when the “Do Not Disturb” service is deactivated. It should be noted that the “Do Not Disturb” service may be deactivated on request by the user of the terminal 120, as will be seen, but also that the service may be deactivated automatically. For example, a maximum duration of operation of the “Do Not Disturb” service may be defined. This duration may be common to all users or selected by the user of the terminal 120 when activating the service, e.g. by indicating a maximum duration of operation of the service in the message 201 activating the service.

If on the contrary the user of the terminal 110 judges that the message 205 needs to be sent urgently to the terminal 120, then the terminal 110 sends a message 210 to the server 100. This message 210 is sent by responding to the message 207 received by the terminal 110. In other words, the message 210 is sent to the sender identifier NUM i or NUM d of the message 207. Messages intended for the identifiers NUM i associated with the white lists or intended for the identifier NUM d are therefore sent to the server 100.

Step 211 corresponds to the reception by the server 100 of a message 210 to NUM j from NUM 110. In other words, the recipient field of the message 210 includes an identifier NUM j. The server then determines whether NUM 110 belongs to a predefined list, a predefined list associated with an identifier NUM k. If NUM k and NUM j correspond, i.e. they match, then the server 100 retrieves in the database 103 a recorded message 212, sent by the terminal 110 to the terminal 120, and sends this message 212 to the terminal 120. The message 212 corresponds to a message 205 previously recorded in the database 103.

If NUM 110 does not belong to a predefined list, then the server 100 verifies that NUM j corresponds to NUM d, i.e. that NUM j matches NUM d. If this is the case, then the server 100 retrieves in the database 103 a recorded message 212, a message sent by the terminal 110 to the terminal 120, and sends this message 212 to the terminal 120.

Otherwise, i.e. an identifier NUM j does not correspond to the identifier associated to with the list of identifiers to which NUM 110 belongs, or if NUM 110 does not belong to a list, to NUM d, then the message 210 is ignored by the server 100.

This step of verifying the consistency between NUM j and an expected identifier prevents a user of a list associated with one identifier sending a message 210 to another identifier. In other words, assuming that the identifiers NUM i and NUM d correspond to premium rate numbers, this prevents a user sending a message 210 to a number different from the premium rate number that they should use. This is possible if this user does not respond to the message 207—i.e. reuses the number of the sender of the message 207 as recipient—but edits a message 210 by choosing a recipient themselves. Without this verification, a user of a terminal 110 could choose the lesser rate premium rate number, weakening the effect of the method.

In another alternative embodiment, the step of verifying the agreement between NUM j and NUM k or NUM d respectively is not performed. Indeed, assuming that the charges for sending messages to the second and third identifier would be different, and in order to prevent a first user sending a fourth message 210 only to the less expensive identifier, it is useful to verify that the destination identifier of the fourth message 210 does correspond to the sender identifier of the second message 207. In other words, it is useful to verify that the first user does respond to the second message 207 using the identifier contained in the sender field of the second message. However, assuming that the first user will respond to the second message 207, and therefore that the message 210 will actually be sent to the correct identifier corresponding to the sender of the second message 207, this verification step may be ignored. In other words, according to the security level sought, the step of verifying the matching of identifiers may not be performed.

In this case, after receiving the message 210, the server 100 determines whether the identifier NUM j matches a known identifier, i.e. an identifier associated with a predefined list or NUM d. If so, the server then retrieves a recorded message in the database 103 which is intended for the second terminal 120 then sends this retrieved message to the second terminal 120. If not, the message 210 is ignored.

A message 213 may be sent by the server 100 to the terminal 110 for confirming successful reception of the message 210. Alternatively, the message 213 is sent to indicate to the user of the terminal 110 that a message 212 has actually been sent to the terminal 120.

According to the embodiment of the method of the present invention, the message 212 sent to the terminal 120 may be retrieved in the database 103 in a different way.

According to one method, the message 212 recorded in the database 103 which is retrieved and sent to the terminal 120 corresponds to the last message sent by the terminal 110 to the terminal 120 to have been recorded in the database 103. In other words, the to retrieved message is the last of the recorded messages, sent by the first terminal 100 to the second terminal 120. This method thus allows an “unblocking” of the recorded messages on the “last in, first out” principle. Alternatively, the message 212 retrieved and sent may correspond on the contrary to the first message sent by the terminal 110 to the terminal 120 to have been recorded in the database 103, according to the “first in, first out” principle.

According to another alternative method, the message 207 includes a reference for identifying the message 205 recorded in the database. The message 210 includes this same reference, which allows the server to retrieve in the database 103 the message 205 corresponding to this reference. The message 212 sent then corresponding to the message 205 previously recorded which has as a reference the reference included in the message 210. A message 205 received by the server 100 is therefore recorded in the database 103 in association with a reference, this same reference being sent in the message 207 in return. The provision of this reference in a message 210 allows the message recorded in the database 103 to be retrieved and sent to the second terminal 120. Assuming that multiple messages 205 are sent by the terminal 110 to the terminal 120, this alternative method can therefore be used to select which of these multiple messages will be retrieved and sent following the reception by the server 100 of a message 210. The selection being made by the provision in the message 210 of the reference corresponding to the message recorded in the database 103, the reference received in a message 207.

It should be noted that the message 212 retrieved in the database and sent to the terminal 120 is then deleted from the database 103.

According to the embodiment, a message 214 is sent by the terminal 120 to the terminal 110 to indicate the successful reception of the message 212.

Thus, when the “Do Not Disturb” service is active for a terminal 120, any message 205 sent by a terminal 110 to the terminal 120, the identifier of which is not included in a gray or green list associated with the terminal 120 will be recorded by the server 100 in a database 103. The message 205 is therefore not delivered to the terminal 120 at this stage. A message 207 will be sent in return to the terminal 110, the sender field of this message 207 will be dependent on whether the identifier of the terminal 110 belongs to a predefined list associated with the terminal 120. The user of the terminal 110 has the possibility of responding to this message 207 by a message 210 to unblock the sending of a message 205 previously sent. Unblocking will be understood to mean retrieving in the database 103 a message, sent by the terminal 110 to the terminal 120 and previously recorded in the database 103 then this message being sent to the terminal 120. According to the embodiment, the retrieved message is then deleted from the database 103.

Step 221 corresponds to the deactivation by the user of the terminal 120 of the “Do Not Disturb” service. It should be noted that as seen previously, deactivation may be automatic, e.g. after expiration of a predefined time period. Other criteria for activation or automatic deactivation of the service are possible. For example, a synchronization with a diary application on the second terminal 120 may activate and terminate the service automatically at the start and end of a meeting. The activation or deactivation of the service may also be triggered by the position of a sensor on the terminal 120, the face down position on a table corresponding, for example, to the automatic activation of the “Do Not Disturb” service. The user of the terminal 120 may also define hourly ranges for activating the service. Coupling with a geolocation application may also allow the service to be automatically activated or deactivated when the terminal is located in certain places, possibly adding hourly criteria thereto. In these cases, as for automatic deactivation following the expiration of a time period, the server 100 may automatically deactivate the service. In other cases, the server may need to receive a message 220 indicating the deactivation of the “Do Not Disturb” service for the terminal 120. The server 100 thus receives a message 220 sent by the second terminal 120 requesting deactivation of the service. In both cases, the server 100 retrieves all the messages 222 recorded in the database 103 and intended for the terminal 120 and sends them to the terminal 120. These messages 222 may then be deleted from the database 103.

It should be noted that the messages 222, just like the messages 212, have a sender identifier corresponding to the original sender of the message, that is to say, for example, NUM 110 for a message 205 initially sent by the terminal 110.

Following the deactivation of the service, any message sent to the terminal 120 will be delivered to it normally. Deactivation, following the example of the activation of the service, may include a step of modifying the routing of messages to the terminal 120.

The method of filtering includes a step 216, which could equally be executed when the “Do Not Disturb” service is active or not, this step 216 corresponding to the updating or configuration of one or more lists by the user of the terminal 120. This updating of a predefined list associated with the terminal 120 may be done by sending messages 215, including, for example, identifiers to be added to a list, the list being identified by a pre-established reference. The user of the terminal 120 may therefore customize and manage the lists.

According to one embodiment, the method of filtering previously described has the feature that the identifiers NUM i associated with the predefined lists or the identifier NUM d, used by default when sending the message 207 as sender, and accordingly used as a recipient identifier of the message 210 sent by the terminal 110, correspond to premium rate numbers. Thus, after receiving a 207 type message, in addition to the need for the user to have to assess whether or not they really wish to disturb the user of the terminal 120, and if so, take the time to send a message 210, the user of the terminal 110 will have to decide whether they are willing to pay for this cost corresponding to the premium rate number. The user of the terminal 120 may thus set up a number white list corresponding to known user terminals, for which the premium rate will be low or even zero. Conversely, for numbers outside this list, or belonging to other lists, the premium rate will be higher. It should be noted that the premium rate associated with the identifier NUM d, applied by default for an identifier that does not belong to a list, is not necessarily the highest premium rate, the user of the terminal 120 being able to define a user list for which the premium rate is maximum.

According to one embodiment, all or part of the collected premium rate is paid to the service user, or to any other organization or entity, possibly defined by the user of the service.

According to one embodiment of the invention, in the case of a plurality of identifier lists, the same identifier or number may only belong to a single list. In an alternative embodiment, if an identifier has to belong to multiple lists, then one list would be considered by the server 100 as taking priority over the other lists. In terms of implementation, this may mean that the method of filtering described may proceed sequentially with the process of determining an identifier in a list if there are multiple lists, the priority lists being scanned first (e.g. first the green list, then the white lists, then the gray list, etc.). The sequence may be defined by the user of the service.

According to a complementary embodiment, the messages 207 and 210 include an indication of the identifier of the recipient of the message 205. Indeed, in the case of sending a message to multiple users having activated the “Do Not Disturb” service, the server 100 may send back to the sender of the message 205 a different message 207 per recipient having activated the service, the different messages 207 being distinguished by information on the particular recipient. The user of the message 205 may then send a message 210 including a reference to the recipient number to only unblock this single message to this single recipient. It should be noted that as seen previously, the server 100 may then unblock either the first message to have been recorded in the database 103, or the last, or a message identified by a particular reference.

Alternatively, according to another embodiment, a single message 207 is sent by the server 100 in response to a message 205 sent to a plurality of terminals in activated “Do Not Disturb” mode. A single message 210 is then sufficient to unblock the sending of the waiting message to the plurality of destination terminals.

According to an alternative embodiment, the various steps of the method are partly performed by the terminal 120, the service taking the form of an application running on the terminal 120. A server 100, connected with terminal 120—for example by an IP data connection—is used to execute some steps of the method. The messages 201, 203, 212, 215, 217, 220 and 222 are internal messages to the application running on the terminal to 120. The terminal 120 running the application, when the “Do Not Disturb” mode is active, may not react to the reception of a message 205 in order not to disturb the user. The message 205 is recorded on the terminal 120. The terminal 120 sends an instruction to the server 100 to send a message 207 to the terminal 110 indicating to it that the terminal 120 is in “Do Not Disturb” mode. The message 207 includes as previously a sender field corresponding to an identifier NUM i that is possibly premium rate. In case of reception of a message 210 by the server 100, the latter sends an instruction to the terminal 120 to unblock the corresponding message 205, i.e. the message is retrieved in the database 103 of the terminal and presented so as to give the illusion to the user of the terminal that it has only just been received.

According to an alternative embodiment, the method of filtering messages is applied to voice communications—or voice and video for a video conferencing communication—between the first and second terminal. More specifically, the method of filtering messages is applied to the filtering of messages corresponding to requests for establishing communications (e.g. voice or video) to the second terminal (in other words, voice or video calls to the second terminal 120). In this case, FIG. 2 should be read as follows:
the message 205 corresponds to a request for establishing communication sent by the terminal 110 to the terminal 120. It may be a voice, voice and video, etc. communication.
step 206 corresponds to the interception by the server 100 of this request for establishing a communication with the terminal 120. The information corresponding to this request is recorded in the database 103.
according to one embodiment, a voice message may be broadcast by the server 100 to the terminal 110, a message informing, for example, the user of the terminal 110 that the user of the terminal 120 does not wish to be disturbed. The broadcast message may be adapted according to whether the identifier of the terminal 110 belongs to a pre-defined list; alternatively or complementarily, the call may be redirected—directly or after broadcasting the voice message therefore—to a voicemail of the user of the terminal 120,
the message 207 corresponds to a message, e.g. an SMS, which is sent to the terminal 110 by the server 100, a message sent with a sender field including an identifier NUM i dependent on whether the identifier of the terminal 110 belongs to a predefined list, as seen previously. This message informs the user of the terminal 110 of the fact that the user of the terminal 120 does not wish to be disturbed, but that it is possible to reach the user of the terminal 120 at the number corresponding to the identifier NUM i, this identifier possibly corresponding to a premium rate number.
if the user of the terminal 110 wishes to reach the user of the terminal 120, they resend a message 210 requesting the establishment of communication (or a call) to the identifier NUM i, a call that will be received by the server 100. The server 100 will then place the terminal 110 in communication with the terminal 120. To do so, the server 100 will itself send a call to the terminal 120. The call will be billed to the user of the terminal 110 according to the cost corresponding to the premium rate number NUM i.
When the user of the terminal 120 terminates the service (step 221), the information concerning the requests for establishing communications with the terminal 120 will be retrieved in the data base 103 and sent to the terminal 120. In other words, on the deactivation of the “Do Not Disturb” service the terminal 120 will receive a log of the filtered calls. Alternatively, the terminal 120 may be sent updates by the server 100—in real-time or delayed—of the filtered calls log.

1. A method of filtering messages sent by a first terminal to a second terminal, the first terminal being associated with a first identifier, the terminals being connected via at least one communication network, the communication network including a server connected to a database, the database including at least one first predefined list of identifiers, the method performed by the server and comprising:
receiving a first message sent by the first terminal to the second terminal,
recording the first message in the database,
determining whether the first identifier belongs to the first list;
sending a second message to the first terminal, the second message including a sender field matching a second identifier if the first identifier belongs to the first list, and the second message including a sender field matching a third identifier if the first identifier does not belong to the first list.

2. The method of claim 1, the method further including, subsequent to sending the second message to the first terminal:
receiving a third message sent by the second terminal requesting the deactivation of the filtering service provided by the present method,
sending to the second terminal (120) the messages recorded in the database (103) which are intended for it.

3. The method of claim 1, the method further including, subsequent to sending the second message to the first terminal:
receiving a fourth message sent by the first terminal, the recipient field of the fourth message including a fourth identifier,
if the fourth identifier matches the second identifier or the third identifier, retrieving a recorded message in the database which is intended for the second terminal, and sending the retrieved message to the second terminal and
ignoring the fourth message if the fourth identifier does not match either the second identifier or the third identifier.

4. The method of claim 3, wherein the retrieved message is the last recorded message sent by the first terminal and intended for the second terminal, the method further including this retrieved message from the database after it has been sent to the second terminal.

5. The method of claim 3, wherein the second message includes a first reference for identifying the first message recorded in the database, the fourth message includes a second reference corresponding to the first reference, and the retrieved message sent to the second terminal is retrieved from the database using the second reference.

6. The method of claim 1, wherein the database includes a second predefined list of identifiers, the method further including, after the reception of the first message:
determining whether the first identifier belongs to the second list, and
if the first identifier belongs to the second list, transmitting the first message to the second terminal (120) without sending the second message (207).

7. The method of claim 1, wherein the database includes a third predefined list of identifiers, the method further including, after the reception of the first message:
determining whether the first identifier belongs to the third predefined list, and
if the first identifier belongs to the third list, recording the first message in the database without sending the second message.

8. The method of claim 1, wherein at least one of the second and third identifiers corresponds to a value-added service number.

9. The method of claim 1, wherein the messages are of the short message type.

10. The method of claim 1, wherein a message includes at least one message of the short type.

11. A server for implementing a message filtering method, the server being connected to a database and a communication network, a communication network connected to a first and second terminal (110) and (120), the server being configured to:
receive a first message sent by the first terminal to the second terminal,
record the first message in the database,
determining determine whether the first identifier belongs to the first list; and
a second message to the first terminal, the second message including a sender field matching a second identifier if the first identifier belongs to the first list, and the second message including a sender field matching a third identifier if the first identifier does not belong to the first list.

12. A non-transitory computer readable medium having stored thereon instructions, which when executed by a processor of a server connected to a database and at least one communication network, cause the server to perform a method including:
receiving a first message sent by a first terminal to a second terminal;
recording the first message in the database,
determining whether the first identifier belongs to a first list of predefined identifiers stored in the database;
sending a second message to the first terminal, the second message including a sender field matching a second identifier if the first identifier belongs to the first list, and the second message including a sender field matching a third identifier if the first identifier does not belong to the first list.
